(19) United States
(12) Patent Application Publication
(10) Pub. No.: US 2025/0247388 A1
(43) Pub. Date: Jul. 31, 2025

(54) TIME-BASED ONE-TIME PASSWORD ON AUTHENTICATION TOKEN

(71) Applicant: Capital One Services, LLC, McLean, VA (US)

(72) Inventors: Kevin OSBORN, Newton Highlands, MA (US); John JONES, Leesburg, VA (US); Sophie BERMUDEZ, Bend, OR (US)

(21) Appl. No.: 18/422,420

(22) Filed: Jan. 25, 2024

(51) Int. Cl. H04L 9/40; H04L 9/30

(52) U.S. Cl. CPC H04L 63/0853; H04L 9/30; H04L 63/0846

(57) ABSTRACT

The disclosed systems and methods are directed to an implementation of time-based authentication with a contactless card based on remotely provisioned timing data. In one described implementation the timing information is provided by an external agent such as a client device and/or a remote verification server associated with the user account. The timing information is then incorporated into a cryptogram generation process executing on the contactless card, resulting in creation of an encrypted time-based token. The authentication request message that includes the time-based authentication token, may be further supplemented by the inclusion of the timing information separately encoded using, for example, public key cryptography. This modification of the authentication request message generated by the contactless card, enables an additional time-based filtering mechanism that may be performed by a third-party client device.

### FIELD OF THE DISCLOSURE

The present disclosure relates to authenticating users with time-based information. In particular in a contactless card implementation wherein the timestamp is provided by an external source.

### BACKGROUND

A time-based counter is a common feature of systems and devices used in conventional one-time password (OTP) generation. Time-based counter are generally used to create time-restricted authentication tokens which can provide a measure of security due to its restricted validity time window. Implementation of such time-restricted tokens requires a running clock to facilitate dynamic generation of timestamps. However, many transaction card, used for user authentication or electronic transactions, are not equipped with internal power source, such as a battery, in order to maintain a running clock.

These and other deficiencies exist. Therefore there is a need for a system and process to enable implementation of time-based authentications with transaction cards without an internal timing source, in order to overcome these deficiencies.

### SUMMARY OF THE DISCLOSURE

Aspects of the disclosed embodiments include a system for user authentication with a transaction card comprising: an authentication processor configured to: transmit a first timestamp to a contactless card via an intermediary device, the first timestamp corresponding to a first time interval; the contactless card being configured to: generate a first time-based cryptogram with a shared secret key and the first timestamp received from the authentication processor; transmit an authentication request comprising the first time-based cryptogram to a second device (e.g., a merchant transaction device), wherein the authentication request is forwarded, by the second device, to the authentication processor for validation; the authentication processor being further configured to validate the first time-based cryptogram using the secret key and a second timestamp corresponding to a reception of the time-based cryptogram, wherein the second timestamp falls within the first time interval.

Embodiments of the present disclosure further provide a method for user authentication with a transaction card comprising: transmitting, by a first device, a first timestamp to a contactless card via an intermediary device, wherein the first timestamp is associated with a first time interval; generating, by contactless card, a first time-based cryptogram using a secret key shared with the first device and the first timestamp received from the first device; transmitting, by the contactless card, an authentication request comprising the first time-based cryptogram, via the intermediary device, to a second device, wherein the authentication request is forwarded, by the second device to the first device; and validating, by the first device, the first time-based cryptogram using the secret key and a second timestamp associated with a reception of the time-based cryptogram by the first device, wherein the second timestamp falls within the first time interval.

Another embodiment of the present disclosure further provide a non-transitory computer readable medium containing computer executable instructions that, when executed by a computer hardware arrangement, cause the computer hardware arrangement to perform procedures comprising: transmitting, by a first device, a first timestamp to a contactless card via an intermediary device, wherein the first timestamp is associated with a first time interval; generating, by contactless card, a first time-based cryptogram using a secret key shared with the first device and the first timestamp received from the first device; transmitting, by the contactless card, an authentication request comprising the first time-based cryptogram, via the intermediary device, to a second device, wherein the authentication request is forwarded, by the second device to the first device; and validating, by the first device, the first time-based cryptogram using the secret key and a second timestamp associated with a reception of the time-based cryptogram by the first device, received from the contactless card, wherein the wherein the second timestamp falls within the first time interval.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates an exemplary system implementation, in accordance to some embodiments of the present disclosure.

FIG. 2 illustrates a front-view diagram of a contactless card, in accordance to some embodiments of the present disclosure.

FIG. 3 illustrates an overview of card-integrated chip with processing and memory elements, in accordance to some embodiments of the present disclosure.

FIG. 4 illustrates an exemplary key diversification and cryptographic validation process associated with the contactless card operation, in accordance to some embodiments of the present disclosure.

FIG. 5 illustrates Near-field communication for proximity-based operation of the contactless card in accordance to some embodiments of the present disclosure.

FIG. 6 illustrates an example operational flow diagram for generation of time-based cryptogram using remotely-provided timestamp, in accordance to some embodiments of the present disclosure.

FIG. 7 illustrates an example operational flow diagram for time-based cryptographic authentication supplemented with outside the cryptogram timestamps, in accordance to some embodiments of the present disclosure.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A common feature of conventional one-time password (OTP) systems is a time-based token such as the RSA Secure ID. Generally, these token have a limited time window during which they are valid. However, to implement these tokens, one generally needs a battery powered device in order to generate a time-based counter value. Many contactless cards, however, do not have an internal battery. Such contactless cards may operate by drawing power from a near-field communication field (e.g., NFC) of a reader device, which may temporarily provide the required power while the card is within the communication field of the reader. However generating timing information requires a running clock and therefore a battery. In order to provide a solution for this challenge, aspects of the present disclosure describe system and process for implementation of time-based authentication with contactless cards without an internal clock and therefore no capability to generate timing information.

In accordance to one aspect of the present disclosure the timing information, required for generation of a time-based token, may be provided by an external entity/device. In accordance to some embodiments the external entity/device may correspond to a remote verification server and/or a third-party client device such as a point of sale and/or a ticket-generating device. The external entity may be in communication with the contactless card via an intermediary user computing and/or communication device with near-field communication (NFC) connectivity to the contactless card. In one example, the timing information may be provided as part of a nonce data that would be included in the cryptogram.

As described above, the timing information for integration into or inside the cryptogram, may be provided by the client and/or verification server associated with a corresponding user account. The sender of the time datum or timestamp may include the same timing information in the decryption of the received cryptogram. For a match to be established the timestamp used in the computation of the cryptogram may be required to fall within a time-window of validity (e.g., as may be implemented by a time-based counter). In some examples, the validation of the cryptogram may be based on a time window around the current time and if the timestamp used in computation of the cryptogram does not fall within the designated time window then the validation would fail due to a mismatch in the outcome of the decryption process. In some examples, the validation process may be further based on the verification of the time-based cryptogram based on one time-window back and/or one window forward with respect to a current time maintained by the validating device. In some embodiments, the time window may correspond to a future time with respect to the current time, such that a transaction message may not be valid until the indicated time window.

In accordance to another aspect of the present disclosure, time based information may also be included “outside” of the time-based cryptogram in addition to being integrated within the cryptogram. For example, in cases of short-term access (e.g., restricted by time and/or location) and/or cases where validity confirmation is not a critical concern, timing information may be explicitly included outside the cryptogram in order to perform a quick preliminary check. For example, a quick verification of timing information included outside the cryptogram may be performed by a merchant device to provide an initial filtering of transaction requests that are outside a pre-defined time window prior to verification of the transaction cryptogram that may also be included in the transaction request. An example scenario may be represented by a concert whereby tickets may be stamped for a particular entry time and electronic ticket transactions that fall outside a pre-defined window (e.g. associated with an expired and/or invalid timestamp in the card-transmitted message) may be rejected by a ticketing system. In some embodiments, the timing verification routine may be programmed into the ticketing system. Additionally or alternatively information may be included in the card-transmitted message that would specify the resolution/length of the time window. In some embodiments the length/resolution of the time window maybe an adjustable parameter that can be set differently according to different applications, conditions, and/or user preferences.

In accordance to some embodiments, the timing information included outside of the cryptogram (e.g., time-based air key token) may be obscured in a reversible way such that it may be readily validated by other authorized parties. For example, a public key cryptography approach may be adapted for encrypting the timing datum or timestamp with a private key which could then be validated by any entity with a corresponding public key. As such, in accordance to some embodiments, a different cryptographic process may be applied to the outside portion of a time-based air key token (e.g., inside portion composing the time-based cryptogram). In some embodiments, generation of the inside portion (e.g., the time-based cryptogram) may be tied to one or more cryptographic protocol associated with a set of distinct master/origin and/or card-specific keys. The inside portion, as such, may be used for protecting/encrypting sensitive user and financial account information included in a transaction request. Accordingly, the time-based cryptogram may need to be validated by a verification service/process associated with one or more relevant user financial accounts. However, outside portion of the cryptogram, may be obscured using for example a public key cryptography and may be independently validated by any entity with a corresponding public key (e.g., ticket-taking devices) without any communication with a back-end verification server/server associated with the user account.

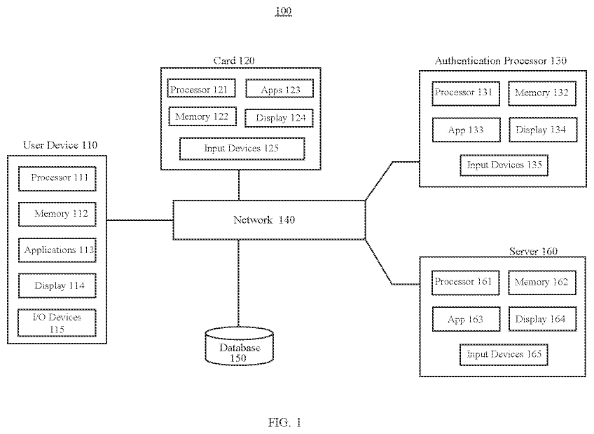

FIG. 1 illustrates a system 100 according to an exemplary embodiment. The system 100 may comprise a user device 110, a card 120, an authentication processor 130, a network 140, a database 150, and a server 160. In some embodiments, server 160 may correspond to a remote client server (e.g., one or more merchant servers). Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

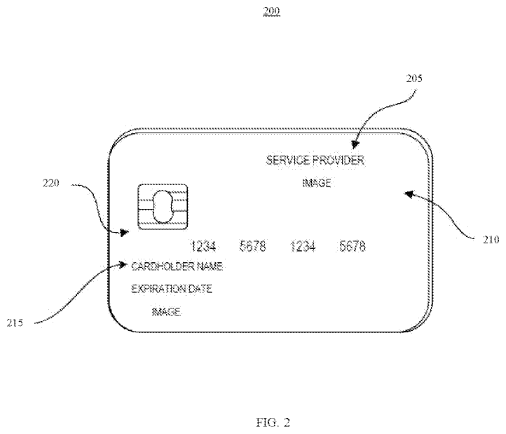

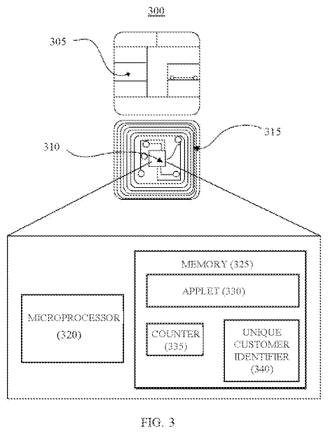

System 100 may include one or more contactless cards 120 which are further explained below with reference to FIG. 2 and FIG. 3. In some embodiments, contactless card 120 may be in wireless communication, utilizing NFC in an example, with user device 110.

System 100 may include authentication processor 130. The authentication processor 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The authentication processor 130 may include a processor 131, a memory 132, and an application 133. The processor 131 may be a processor, a microprocessor, or other processor, and the authentication processor 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the authentication processor 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the authentication processor 130. In some examples, the authentication processor 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The authentication processor 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the authentication processor 130 that can be available and supported by the authentication processor 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network and may be configured to connect the user device 110, the contactless card 120, the authentication processor 130, the database 150 and the server 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like. In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 160 or may be hosted externally of the server 160, such as by a server, by a cloud-based platform, or in any storage device that is in data communication with the server 160.

The server 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 160 may include a processor 161, a memory 162, and an application 163. The processor 161 may be a processor, a microprocessor, or other processor, and the server 160 may include one or more of these processors. The server 160 can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the server 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the server 160. In some examples, the server 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the authentication processor 130 that is available and supported by the authentication processor 130, such as a touch-screen, keyboard, mouse, cursor-control device, touch-screen, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the card 120, the authentication processor 130, the network 140, the database 150, and the server 160 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates a contactless card 200 according to an exemplary embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2).

FIG. 3 illustrates a contactless card 200 according to an exemplary embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamper-proofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

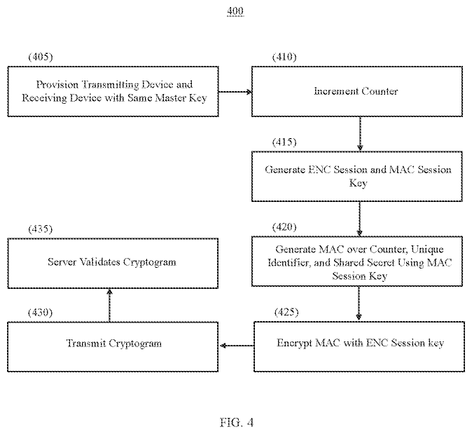

FIG. 4 is a flow chart of method 400 of key diversification according to an exemplary embodiment.

In some examples, a sender and recipient may desire to exchange data via a transmitting device and a receiving device. In some embodiments, the transmitting device is the contactless card, and the receiving device is the server. In other embodiments, the transmitting device and the receiving device are network-enabled computers, as defined herein. As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like. The transmitting device and the receiving device may be network-enabled computer devices. In some examples, the transmitting device may comprise a contactless card and the receiving device may comprise a server. In other examples, the receiving device may comprise a user device or a user device application.

The method 400 can begin with step 405. In step 405, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 410, the transmitting device may take the selected cryptographic algorithm, and using the master symmetric key, process the counter value 335. For example, the transmitting device may select a symmetric encryption algorithm, and use a counter which updates with every conversation between the transmitting device and the receiving device The one or more counters 335 may comprise a numeric counter sufficient to store an integer. The transmitting device may increment the counter one or more times. In step 415, the transmitting device generates two session keys: one ENC (encryption) session key and one MAC (message authentication code) session key. The transmitting device may encrypt the counter value with the selected symmetric encryption algorithm using the master symmetric key to create a session key.

In step 420, the transmitting device generates the MAC over the counter 335, the unique customer identifier 340, and the shared secret MAC session key. The customer identifier 340 may comprise a unique alphanumeric identifier assigned to a user of the contactless card, and the identifier may distinguish the user of the contactless card from other contactless card users. In some examples, the customer identifier 340 may identify both a customer and an account assigned to that customer and may further identify the contactless card associated with the customer's account.

In step 425, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 430, the transmitting device transmits a cryptogram to the receiving device. The cryptogram can include the applet information 330, the unique customer identifier 340, the counter value 335, and the encrypted MAC.

In step 435, the receiving device validates the cryptogram. For example, the receiving device generates its own UDKs (unique diversified keys) using the unique customer identifier 340 and the master key. The unique customer identifier is derived from the validated cryptogram. Recall that the receiving device has already been provisioned with the master key. The receiving device generates two session keys: one ENC (encryption) session key and one MAC (message authentication code) session key. The receiving device may generate these session keys from the UDKs and the counter value. The counter value can be derived from the cryptogram. The receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key. The receiving device validates the MAC with the MAC session key generated in step 415. The receiving device may validate the MAC over the unique customer identifier and the counter value.

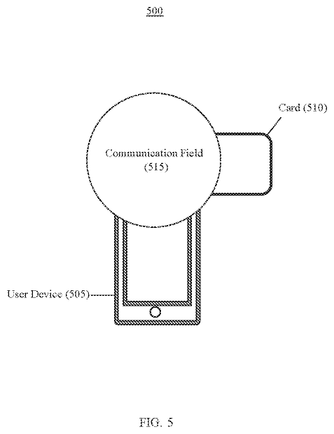

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats, and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the card, when brought in close proximity to each other, can exchange information within the communication field.

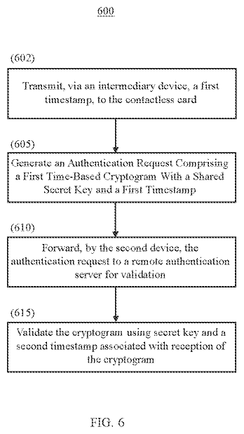

FIG. 6 is a flow chart of method 600 of time-based authentication with a contactless card, wherein timing data is provided by a client device and/or remote authentication server, and incorporated into a cryptogram by the contactless card to generate a time-based cryptogram.

FIG. 6 may begin at step 602. In step 602 a first device, corresponding to the remote authentication server and/or a client device, transmits a first timestamp to a contactless card. The timing data may be transmitted to the contactless card via an intermediary device with NFC connectivity to the contactless card and network connectivity to the timestamp-transmitting device (e.g., remote authentication server associated with the contactless card or a transacting client/merchant device). The first timestamp may be associated with a first time window or time interval. In some embodiments, the first time stamp may correspond to a current time maintained by the timestamp transmitting device.

In step 605, the contactless card may generate a first time-based cryptogram using a secret key shared with the remote authentication server and the externally acquired first timestamp. The first timestamp may be provided by the remote authentication server and/or a merchant transacting device (e.g., client device). The first time-based cryptogram may then be transmitted, as part of an authentication request message to a second device. In some embodiments the second device may correspond to a merchant point of sale (POS) device. The POS device may include a wireless reader unit for enabling direct transmission of the authentication request from the contactless card to the POS device. In some embodiments the transmission of the authentication request may be facilitated by an intermediary device (e.g., a used communication device) with NFC connectivity to the contactless card and wireless network connectivity to the POS device.

In step 610, the authentication request message may be forwarded, by the receiving second device, to the remote authentication server for validation of the time-based cryptogram. Upon receiving the time-based cryptogram, the remote authentication server may decrypt and validate the cryptogram using the shared secret key and a second timestamp associated with reception of the cryptogram from the second device. If the second timestamp falls within a time window associated with the first timestamp the cryptogram is validated, as shown in step 615. In some embodiments, a public key (e.g., as associated with a public key encryption scheme) may be stored onto or acquired by the contactless card. In such embodiments, the contactless card may use the public key to validate a transmitted timestamp (e.g., a timestamp encrypted with a private key corresponding to the public key stored on the contactless card).

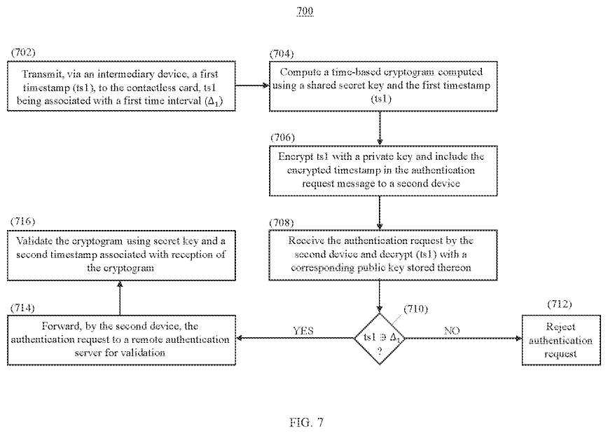

FIG. 7 is a flow chart of method 700 of time-based authentication process with remotely provisioned timing data, further supplemented with an additional time-based filtering mechanism that may be performed by a third-party client device (e.g., merchant POS device). The exemplary method 700 may begin at step 702 whereby a time datum (e.g., a first timestamp) is transmitted to a contactless card. The first timestamp (ts1) maybe provided by an external entity such as an a user account server (e.g., associated with the contactless card account) and/or a third-party client device such as merchant POS device.

In step 704, the contactless card may compute a time-based cryptogram using a shared secret key and the first timestamp (ts1) received from the external entity (e.g. a first device comprising a third-party client device). The contactless may then generate an authentication request comprising the time-based cryptogram and the timestamp (ts1) which may be encrypted for example with a private key, prior to inclusion into an authentication request message. The authentication message may then be transmitted to a second device, as shown in step 706. The second device may correspond, for example, to a third-party merchant POS device interacting with the contactless card.

In step 708, the second device receive the authentication request and decrypt the timestamp (ts1) with a corresponding public key stored thereon. In step 710 the timestamp may be examined in relation to the first time interval. For example, the timestamp maybe verified to be within a first time interval (41). In some embodiments the validation time window may begin immediately after the authentication request is generated and end less than five minutes later. In some embodiment, the time window may begin at some predetermined time after the first timestamp (ts1) is generated. In some embodiments, the time window may being at some predetermined time after the first timestamp is generated and after one or more triggering event are detected. In some embodiments the beginning and end of the time window may be changed in response to one or more triggering events. If the timestamp is determined to be outside of a time window, the authentication request maybe rejected by the receiving POS device without communication with a user account verification server, as illustrated in step 712.

In step 714, upon validating the decrypted timestamp as corresponding to a predetermined time window or time interval, the authentication request message may be forwarded, by the receiving second device, to the remote authentication server for validation of the time-based cryptogram. As described above, the valid time interval, for the private kay encrypted timestamp, may be indicated in the authentication request message itself and/or pre-programmed on the client POS device. Upon receiving the time-based cryptogram, the remote authentication server may decrypt and validate the cryptogram using the shared secret key and a second timestamp associated with reception of the cryptogram from the second device (e.g., client POS device). If the second timestamp falls within a time window associated with the first timestamp the cryptogram is validated and the transaction is approved, as shown in step 716.

According to some embodiments pre-validated tokens (e.g., authenticated time-based cryptograms) may be stored on a user mobile device and used as payload with a private key generated cryptogram which may be validated by a public key of a vendor for transactions conducted within a predetermined time frame. The time frame information maybe included in the transaction request and/or pre-programmed onto the POS devices.

In some embodiments, the validation time interval may be evaluated by the contactless card. In such embodiments, a card-evaluated time window (associated with validation period for a transaction request) may be provided using, for example, a state machine implementation on the contactless card to receive a first timestamp. The contactless card may then perform the required authentication activity if a second transaction request is received within the time frame allotted. If the second transaction request is received outside of the allotted time frame the state machine may be restarted (e.g., return an error identifier).

In some aspects, the techniques described herein relate to a system for user authentication with a transaction card including: an authentication processor configured to: transmit a first timestamp to a contactless card via an intermediary device, the first timestamp corresponding to a first time interval; the contactless card configured to: generate a first time-based cryptogram with a shared secret key and the first timestamp received from the authentication processor; transmit an authentication request including the first time-based cryptogram to a second device; wherein the authentication request is forwarded, by the second device, to the authentication processor for validation; validate, by the authentication processor, the first time-based cryptogram using the secret key and a second timestamp corresponding to a reception of the time-based cryptogram, wherein the second timestamp falls within the first time interval.

In some aspects, the techniques described herein relate to the system of claim, wherein the authentication processor is further configures to encrypt the first timestamp with the shared secret key prior to transmission to the contactless card.

In some aspects, the techniques described herein relate to a system, wherein the first timestamp is associated with a real-world time;

In some aspects, the techniques described herein relate to a system, wherein the contactless card is further configured to include the first timestamp along with the first time-based cryptogram in the authentication request.

In some aspects, the techniques described herein relate to a system, wherein the second device is configured to verify the first timestamp falls within a second time interval, prior to forwarding the time-based cryptogram to the authentication processor.

In some aspects, the techniques described herein relate to a method, wherein the authentication request is rejected by the second device if the first timestamp does not fall within the second time interval.

In some aspects, the techniques described herein relate to a method, wherein the second time interval is predetermined by a client associated with the second device.

In some aspects, the techniques described herein relate to a system, wherein the first timestamp is encrypted with a private key, stored on the contactless card, prior to inclusion in the authentication, and validated by a corresponding public key stored in the second device.

In some aspects, the techniques described herein relate to a system, wherein the intermediary device corresponds to a user communication device with near-field communication (NFC) connectivity to the contactless card and a network connectivity to the authentication processor.

In some aspects, the techniques described herein relate to a method for user authentication with a transaction card including: transmitting, by a first device, a first timestamp to a contactless card via an intermediary device, wherein the first timestamp is associated with a first time interval; generating, by contactless card, a first time-based cryptogram using a secret key shared with the first device and the first timestamp received from the first device; transmitting, by the contactless card, an authentication request including the first time-based cryptogram, via the intermediary device, to a second device, wherein the authentication request is forwarded, by the second device to the first device; and validating, by the first device, the first time-based cryptogram using the secret key and a second timestamp associated with a reception of the time-based cryptogram by the first device, wherein the second timestamp falls within the first time interval.

In some aspects, the techniques described herein relate to a method, wherein the first timestamp corresponds to current time maintained by the first device.

In some aspects, the techniques described herein relate to a method, wherein the authentication request further includes a unique customer identifier retrieved from a memory of the contactless card.

In some aspects, the techniques described herein relate to a method, wherein the contactless card is further configured to include the first timestamp, along with the first time-based cryptogram, in the authentication request transmitted to the second device.

In some aspects, the techniques described herein relate to a method further including: verifying, by the second device, that the first timestamp falls within a second time interval prior to forwarding the time-based cryptogram to the first device, wherein the second time interval is predetermined by a merchant associated with the second device.

In some aspects, the techniques described herein relate to a method, wherein the authentication request is rejected by the second device if the first timestamp does not fall within the second time interval, and wherein the authentication request includes an indication of a length of the second time interval.

In some aspects, the techniques described herein relate to a method, wherein the second time interval corresponds to a same time window as the first time interval.

In some aspects, the techniques described herein relate to a method, wherein the second device corresponds to a merchant transaction device and wherein the second time interval is pre-determined by the merchant.

In some aspects, the techniques described herein relate to a method, wherein the first timestamp is encrypted with a private key, stored on the contactless card, prior to inclusion in the authentication request, and validated by a corresponding public key stored on the second device.

In some aspects, the techniques described herein relate to a method, wherein the intermediary device corresponds to a user communication device with near-field communication (NFC) connectivity to the contactless card and a network connectivity to the authentication processor.

In some aspects, the techniques described herein relate to a non-transitory computer readable medium containing computer executable instructions that, when executed by a computer hardware arrangement, cause the computer hardware arrangement to perform procedures including: transmitting, by a first device, a first timestamp to a contactless card via an intermediary device, wherein the first timestamp is associated with a first time interval; generating, by contactless card, a first time-based cryptogram using a secret key shared with the first device and the first timestamp received from the first device; transmitting, by the contactless card, an authentication request including the first time-based cryptogram, via the intermediary device, to a second device, wherein the authentication request is forwarded, by the second device to the first device; and validating, by the first device, the first time-based cryptogram using the secret key and a second timestamp associated with a reception of the time-based cryptogram by the first device, received from the contactless card, wherein the wherein the second timestamp falls within the first time interval.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

Throughout the disclosure, the term “bank” is used, and it is understood that the present disclosure is not limited to a particular bank or type of bank. Rather, the present disclosure includes any type of bank or other business involved in activities where products or services are sold or otherwise provided.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for user authentication with a transaction card comprising:
an authentication processor configured to:
transmit a first timestamp to a contactless card via an intermediary device, the first timestamp corresponding to a first time interval;
the contactless card configured to:
generate a first time-based cryptogram with a shared secret key and the first timestamp received from the authentication processor;
transmit an authentication request comprising the first time-based cryptogram to a second device; wherein the authentication request is forwarded, by the second device, to the authentication processor for validation;
validate, by the authentication processor, the first time-based cryptogram using the secret key and a second timestamp corresponding to a reception of the time-based cryptogram, wherein the second timestamp falls within the first time interval.

2. The system of claim 1, wherein the authentication processor is further configures to encrypt the first timestamp with the shared secret key prior to transmission to the contactless card.

3. The system of claim 1, wherein the first timestamp is associated with a real-world time.

4. The system of claim 1, wherein the contactless card is further configured to include the first timestamp along with the first time-based cryptogram in the authentication request.

5. The system of claim 4, wherein the second device is configured to verify the first timestamp falls within a second time interval, prior to forwarding the time-based cryptogram to the authentication processor.

6. The system of claim 5, wherein the authentication request is rejected by the second device if the first timestamp does not fall within the second time interval.

7. The system of claim 6, wherein the second time interval is predetermined by a client associated with the second device.

8. The system of claim 4, wherein the first timestamp is encrypted with a private key, stored on the contactless card, prior to inclusion in the authentication, and validated by a corresponding public key stored in the second device.

9. The system of claim 4, wherein the intermediary device corresponds to a user communication device with near-field communication (NFC) connectivity to the contactless card and a network connectivity to the authentication processor.

10. A method for user authentication with a transaction card comprising:
transmitting, by a first device, a first timestamp to a contactless card via an intermediary device, wherein the first timestamp is associated with a first time interval;
generating, by contactless card, a first time-based cryptogram using a secret key shared with the first device and the first timestamp received from the first device;
transmitting, by the contactless card, an authentication request comprising the first time-based cryptogram to a second device, wherein the authentication request is forwarded, by the second device to the first device; and
validating, by the first device, the first time-based cryptogram using the secret key and a second timestamp associated with a reception of the time-based cryptogram by the first device, wherein the second timestamp falls within the first time interval.

11. The method of claim 10, wherein the first timestamp corresponds to current time maintained by the first device.

12. The method of claim 10, wherein the authentication request further comprises a unique customer identifier retrieved from a memory of the contactless card.

13. The method of claim 10, wherein the contactless card is further configured to include the first timestamp, along with the first time-based cryptogram, in the authentication request transmitted to the second device.

14. The method of claim 13 further comprising: verifying, by the second device, that the first timestamp falls within a second time interval prior to forwarding the time-based cryptogram to the first device, wherein the second time interval is predetermined by a merchant associated with the second device.

15. The method of claim 14, wherein the authentication request is rejected by the second device if the first timestamp does not fall within the second time interval, and wherein the authentication request comprises an indication of a length of the second time interval.

16. The method of claim 13, wherein the second time interval corresponds to a same time window as the first time interval.

17. The method of claim 13, wherein the second device corresponds to a merchant transaction device and wherein the second time interval is pre-determined by the merchant.

18. The method of claim 13, wherein the first timestamp is encrypted with a private key, stored on the contactless card, prior to inclusion in the authentication request, and validated by a corresponding public key stored on the second device.

19. The method of claim 13, wherein the intermediary device corresponds to a user communication device with near-field communication (NFC) connectivity to the contactless card and a network connectivity to the first device, the first device corresponding to an authentication processor associated with the contactless card.

20. A non-transitory computer readable medium containing computer executable instructions that, when executed by a computer hardware arrangement, cause the computer hardware arrangement to perform procedures comprising:
transmitting, by a first device, a first timestamp to a contactless card via an intermediary device, wherein the first timestamp is associated with a first time interval;
generating, by contactless card, a first time-based cryptogram using a secret key shared with the first device and the first timestamp received from the first device;
transmitting, by the contactless card, an authentication request comprising the first time-based cryptogram, via the intermediary device, to a second device, wherein the authentication request is forwarded, by the second device to the first device; and
validating, by the first device, the first time-based cryptogram using the secret key and a second timestamp associated with a reception of the time-based cryptogram by the first device, received from the contactless card, wherein the wherein the second timestamp falls within the first time interval.
